(19) United States
(12) Patent Application Publication
(10) Pub. No.: US 2004/0267685 A1
(43) Pub. Date: Dec. 30, 2004

(54) Storage container for emergency information and method of assisting rescue personnel

(76) Inventors: Thomas G. Sharland, Ajax (CA); Robert J. Oliver, Etobicoke (CA)

Correspondence Address: SMART & BIGGAR, Suite 1500, 438 University Avenue, Box 111, Toronto, ON, M5G 2K8, CA

(21) Appl. No.: 10/602,760

(22) Filed: Jun. 25, 2003

(51) Int. Cl. G06F 15/00; B65D 69/00

(52) U.S. Cl. 706/62

(57) ABSTRACT

An emergency information storage container stores information which facilitates location by rescue personnel of regular building occupants in the event of an emergency situation, such as a fire or gas leak. The information may include the names of individuals or pets regularly occupying the building and the locations in the building which they regularly occupy. Floor plan information may be provided. The storage container is installed at the building. In the event of an emergency, rescue personnel open the container and use the information stored therein to facilitate rescue efforts. The storage container may be provided in a kit which includes instructions for preparing the emergency information, installing the storage container and storing the information in the container. A method for assisting rescue personnel is also provided.

### FIELD OF THE INVENTION

The present invention relates to a storage container for emergency information and to a method of installing a storage container for emergency information.

### BACKGROUND OF THE INVENTION

When an emergency situation such as a fire or gas leak occurs in a residential or commercial building, time is of the essence when it comes to rescuing endangered building occupants. This is of course the reason that rescue vehicles such as fire trucks and ambulances have the right of way over other vehicular traffic when responding to an emergency.

When rescue personnel (e.g. firefighters) arrive at the scene of an emergency, they often have only a very short time in which to gain entry to a building, search for endangered occupants, and remove them from danger. Unfortunately, various impediments to successful rescue may exist.

One possible impediment to rescue is the fact that building occupants may be situated in a remote or hidden corner of the building. Rescuers may inadvertently overlook such occupants because of their unfamiliarity with the building. Rescuers may lose valuable time searching in areas of the building in which occupants are unlikely to be found. This problem may be exacerbated when occupants fail to draw attention to themselves, as may occur when occupants are incapacitated or are simply unaware that a rescue attempt is being made.

Another possible impediment to timely rescue is a lack of information on the part of rescuers about the occupants of the building which, if known, would dictate the use of more effective rescue procedures. For example, if it were known that one or more small children were located in a building, rescue procedures might be modified to include a search of certain hiding places that are only small enough to contain a small child, such as a closet or cabinet. Conversely, if it were known that no small children were located in a building, a decision may be made to refrain from any such searching of small hiding places.

The above-described impediments may similarly hamper efforts to rescue any pets trapped in a building.

When an individual or pet has been successfully located and removed from a building by a rescuer, it may be necessary to immediately provide medical care. However, if no information is available as to the medical background of the individual or pet, the medical care that is provided could be improper.

What is needed is a solution which addresses at least some of these difficulties.

### SUMMARY OF THE INVENTION

An emergency information storage container stores information which facilitates location by rescue personnel of regular building occupants in the event of an emergency situation, such as a fire or gas leak. The information may include the names of individuals or pets regularly occupying the building and the locations in the building which they regularly occupy. Floor plan information may be provided. The storage container is installed at the building. In the event of an emergency, rescue personnel open the container and use the information stored therein to facilitate rescue efforts. The storage container may be provided in a kit which includes instructions for preparing the emergency information, installing the storage container and storing the information in the container. A method for assisting rescue personnel is also provided.

In accordance with an aspect of the present invention there is provided an emergency information storage container kit comprising: a storage container; and instructions for: preparing human readable material to assist rescue personnel in the location of regular occupants of a building; installing the storage container at an installation location at the building; and storing the human readable material in the storage container.

In accordance with another aspect of the present invention there is provided a method of assisting rescue personnel, comprising: preparing human readable material to assist the rescue personnel in locating regular occupants of a building; and installing a storage container at an installation location at the building for storing the human readable material.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a perspective view of a storage container for emergency information embodying the present invention installed in a building;

FIG. 2 is a perspective view of the storage container of FIG. 1 with its door opened to reveal the emergency information cards stored therein;

FIG. 3 illustrates one of the emergency information cards of shown in FIG. 2 in greater detail;

FIG. 4 illustrates another one of the emergency information cards of shown in FIG. 2 in greater detail;

FIG. 5 illustrates a further one of the emergency information cards of shown in FIG. 2 in greater detail; and

FIG. 6 illustrates an emergency information storage container kit.

### DETAILED DESCRIPTION

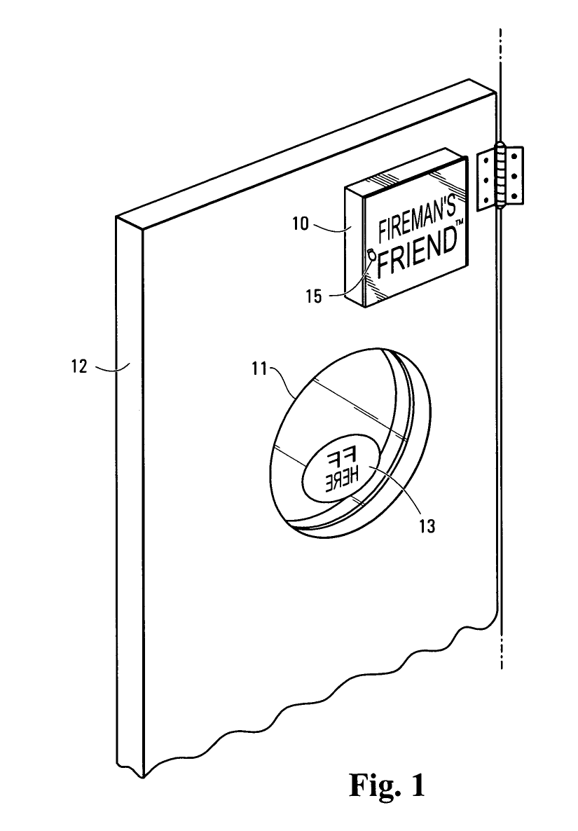

Referring to FIG. 1, an emergency information storage container 10 is shown installed in a building on the interior surface of an exterior door 12. The storage container 10 is made from metal and is mounted to the door 12 with screws or other fasteners. The container 10 has a hinged front door 14 which is closed in FIG. 1. A pull ring 15 facilitates opening of the door 14. The door 14 of container 10 is labelled with an identifying mark to provide an outward indication of the contents of the container for easy identification by rescuers in a emergency situation. In the present case the mark consists of the words FIREMAN'S FRIEND™.

The exterior door 12 has a window 13 in which a sign 13 is displayed. The sign 13 provides an indication (e.g. “FF HERE”, shorthand for “FIREMAN'S FRIEND™ HERE”) that the building has an emergency information storage container 10 installed therein. Sign 13 may be a decal and is displayed so as to be readable by persons on the exterior side of door 12.

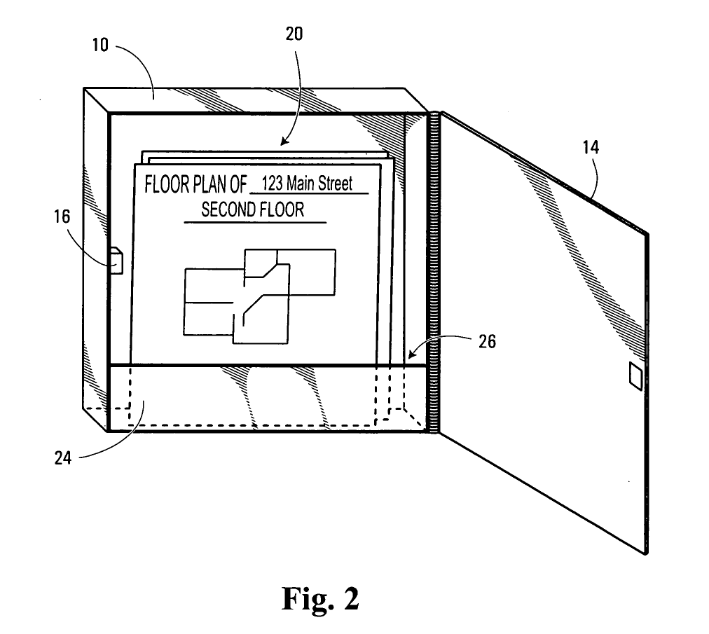

FIG. 2 shows the container 10 of FIG. 1 with its front door 14 opened. The container 10 includes a latching mechanism 16 for selectively latching the front door 14. The latching mechanism 16 may be a magnetic latch, for example, or some other mechanism capable of selectively securing the front door in a closed position and permitting the door 14 to be easily and quickly opened.

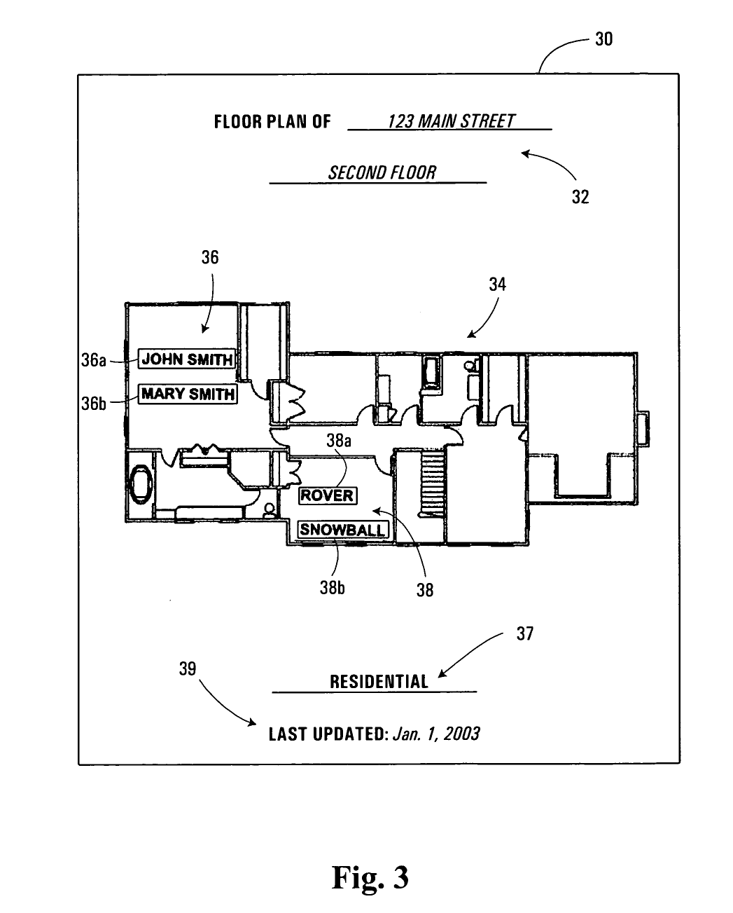

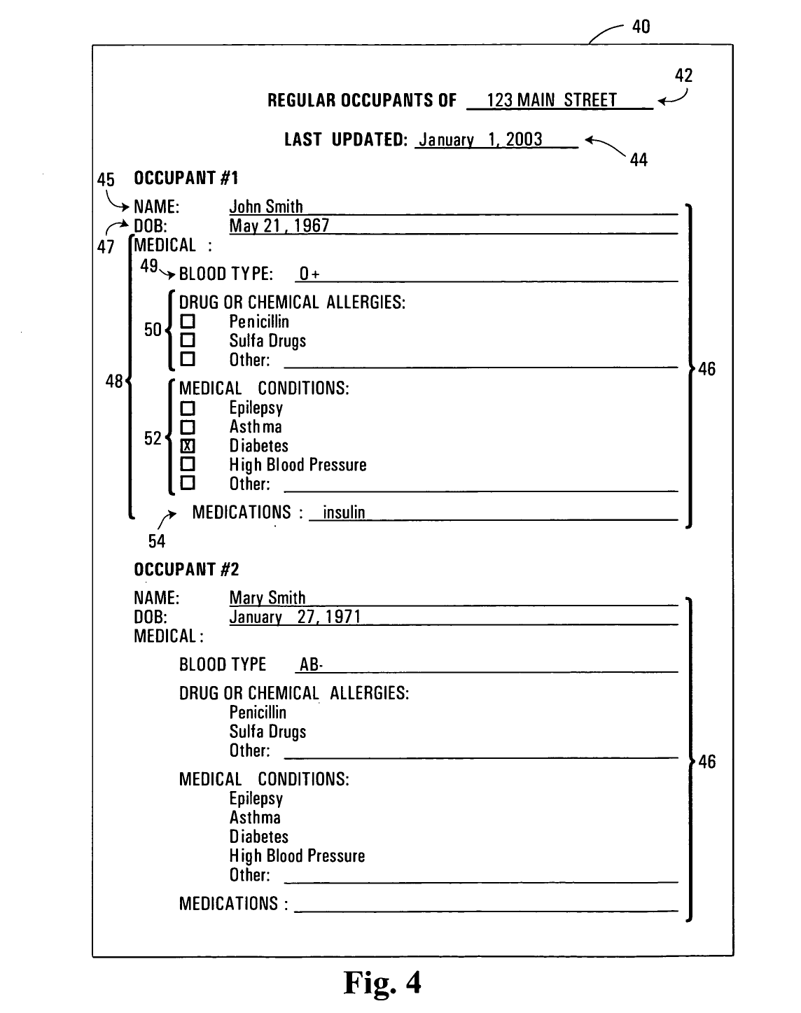

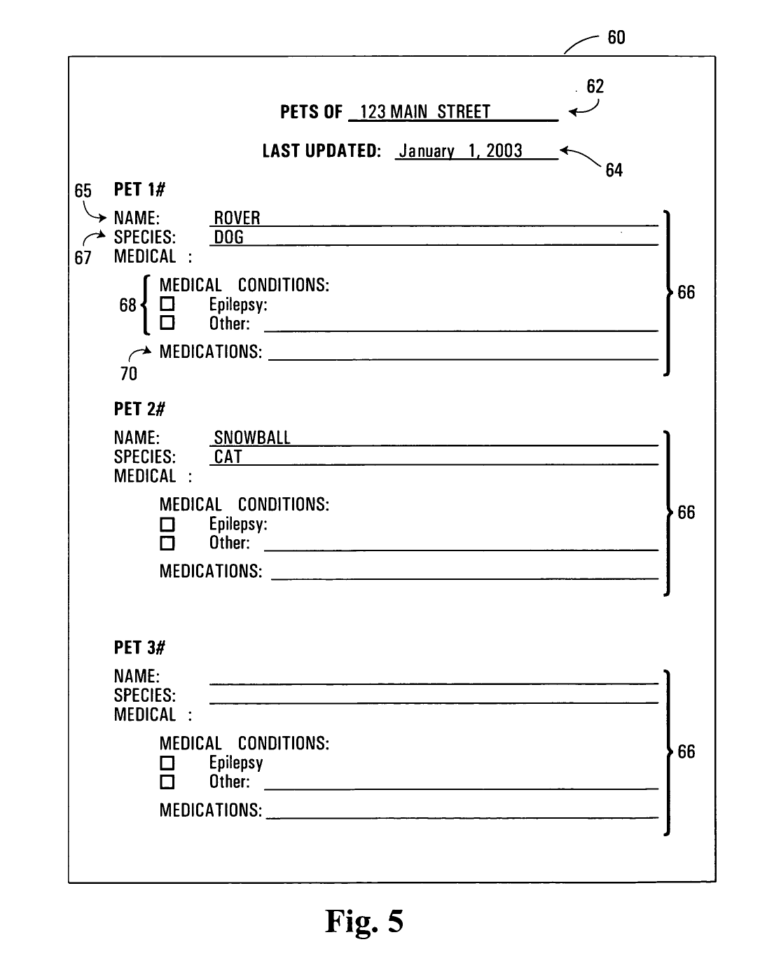

As shown in FIG. 2, the container 10 has a lower lip 24 which defines a well 26 in which a set of emergency information cards 20 are placed. The set of cards 20 provides emergency information for the regular occupants of the building in which the container 10 is installed. In particular, the cards 20 include a floor plan information card 30 (FIG. 3), an occupant information card 40 (FIG. 4), and a pet information card 60 (FIG. 5).

Turning to FIG. 3, the floor plan information card 30 provides an “at-a-glance” summary of the locations regularly occupied by building occupants and pets (if any pets regularly occupy the building).

The floor plan information card 30 includes address and story field 32 indicating the address of the building in which the storage container is installed and the story (or stories) that are regularly occupied. In the present example, the blanks of this field have been completed by an installer of the container 10 to indicate that the floor plan information pertains to 123 Main Street, second floor.

Also included on card 30 is a floor plan 34 of the building story (or stories) identified in field 32. In the present case, the floor plan is of the second floor of a residential building (specifically, a house). The fact that the building is residential versus commercial is indicated on the card 30 at 37, although this is not required.

The floor plan 34 includes occupant location markers 36 for indicating the location(s) regularly occupied by building occupants. In the present example, there are two markers 36, each consisting of an adhesive label. Each of the markers 36 is an indicator displaying the name of an individual who is a regular building occupant. The first marker 36a displays the name of an individual occupant named “John Smith” and the second marker 36b displays the name of another individual “Mary Smith”. The names may be printed onto the markers by the installer of the container 10.

Each marker 36a and 36b is positioned on the floor plan in a position which corresponds with the location of regular occupancy of the named individual. In the present example, both markers 36a and 36b are situated within the floor plan outline of the master bedroom of the house. This indicates that John Smith and Mary Smith regularly occupy the master bedroom.

In the case of residential buildings, the location of regular occupancy will typically be a sleeping location. In the case of a commercial building, the location of regular occupancy may be an office or workplace location. It is understood that the location of regular occupancy identified by occupant location markers 36 may not accurately represent an occupant's location 100% of the time, but rather merely identifies a location in which the occupant is often found, and which may therefore serve as a good place for rescuers to commence their search in the event of an emergency.

Pet location markers 38 are also adhesive labels which similarly identify the floor plan location(s) regularly occupied by pets. In the present example, first and second markers 38a and 38b have been completed and adhered to the floor plan 34 to indicate that pets named “Rover” and “Snowball” regularly occupy another room on the second floor of the house. For pets, the location of regular occupancy may be a typical sleeping location, or alternatively may be the location of a cage or enclosure. The pet markers 38 may optionally be shaped to readily indicate the species of pet (not shown in FIG. 3). For example, marker 38a may have a dog shape and marker 38b may have a cat shape.

It will be appreciated that floor plan information card 30 may include floor plans for more than one story of a building if the locations regularly occupied by individuals or pets span more than one floor. In the present example, no floor plan is provided for the first floor of 123 Main Street because no individuals or pets regularly occupy the first floor.

The floor plan information card 30 also has a last-updated field 39 indicating the date on which the floor plan information was last updated. This field provides an indication of the currency of the information on the card 30.

In the event that locations of regular occupancy for occupants or pets changes over time, the markers 36a, 36b, 38a and 38b can be repositioned on the floor plan 34. If this is done, it is typically desirable to update the “last updated” field 39 to indicate that the information is current.

Referring now to FIG. 4, the illustrated occupant information card 40 provides detailed information regarding the individuals whose locations are marked on card 30 of FIG. 3. Occupant information card 40 includes an address field 42, a “last-updated” field 44, and two identical occupant information sections 46.

Address field 42 and “last-updated” field 44 are similar to fields 32 and 34 of card 30 (FIG. 3), except that story information is omitted from field 42. Story information is omitted because the occupant information provided on card 40 covers all occupants of the building, regardless of which story they regularly occupy.

As shown in FIG. 4, the first occupant information section 46 has been completed for John Smith and the second section 46 has been completed for Mary Smith. Further occupant sections may be provided if the number of occupants exceeds two.

Examining occupant information section 46 more closely, it can be seen that this section includes a name field 45 for indicating the occupant's name and a date of birth field 47 for indicating the occupant's date of birth.

Section 46 also includes a subsection 48 setting out medical information for the named occupant. Subsection 48 includes a blood type field 49 indicative of the blood type of the occupant, an allergies field 50 listing any drug or chemical allergies of the occupant, a medical conditions field 52 listing any medical conditions from which the occupant suffers, and a medications field 54 indicating any medications or prescriptions routinely taken by the occupant. In the present example, these fields have been completed to indicate that John Smith has a blood type of O+, suffers from diabetes, and regularly takes insulin. Some or all of the fields 49, 50, 52 and 54 may include checklists, as shown for fields 50 and 52 in FIG. 4, to encourage thoroughness on the part of those completing card 40.

Although the occupant information of FIG. 4 appears on a single card 40, in alternative embodiments a separate card may be provided for each occupant. In that case, the name of the relevant occupant may be printed prominently on each card, and the totality of the occupant cards may be ordered alphabetically by name to facilitate searching for a particular occupant.

FIG. 5 illustrates a pet information card 60 providing detailed information regarding any pets whose locations are marked on card 30 of FIG. 3. Pet information card 60 includes an address field 62 and a “last-updated” field 64 analogous to fields 42 and 44 of card 40 (FIG. 4). Pet information card 60 further includes three identical pet information sections 66 for a first, second and third pet.

Examining section 66 more closely, it can be seen that the section includes a pet name field 65, a species field 67 for indicating the species of the pet, a medical conditions field 68 for indicating any medical conditions of the pet, and a medications field 70 indicating any medication regularly taken by the pet. In the present example, the first section 66 has been completed to indicate that the pet “Rover” indicated by marker 38a is a dog. The second pet information section 66 has been completed in respect of the second pet named “Snowball”, a cat. The third pet information section 66 has been left blank in the present example as no third pet exists. The number of pet information sections may be greater than or less than three.

Each of cards 30, 40, and 60 may be laminated for durability and to resist water damage.

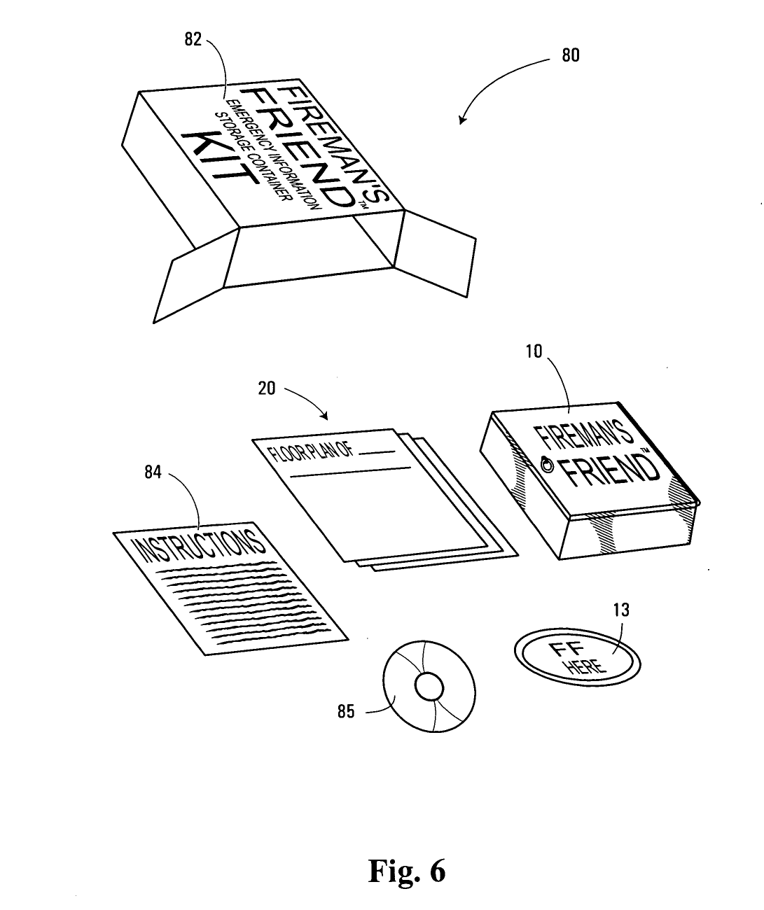

FIG. 6 illustrates a kit 80 which may be made available commercially to consumers desirous of installing an emergency information storage container 10 in a building. The kit 80 may be shipped in a box 82. The kit 80 includes emergency information cards 20 comprising forms to be completed by the consumer, a storage container 10 and sign 13. The kit 80 further includes instructions 84 for completing the forms to create cards 20, installing the storage container 10, storing the cards in the container 10, and displaying the sign 13. The instructions may describe one or more preferred installation locations for mounting the storage container 10 so as to be quickly locatable by rescue personnel at the time of an emergency. Screws or other fasteners (not shown) may be provided in the kit 80 to facilitate mounting of the container 10 to a door or wall for example. The kit may also include a computer readable medium, such as a magnetic or optical disk 85, containing software to facilitate the preparation of cards 20 or for printing cards 20 onto paper provided by a user.

In use, a consumer who has purchased the kit 80 of FIG. 6 may unpack the kit and read the instructions 84. The instructions 84 may instruct the consumer to complete the emergency information cards 20 as illustrated above. Blank fields (e.g. address and story field 32) and markers 36 and 38 (FIG. 3) may be completed with a permanent marker for example. Alternatively, the cards 20 may be preparing through printing with a printer and home computer executing computer software provided by way of computer-readable medium 85 or via the Internet for example. The instructions 84 may instruct the installer to create floor plan 34 through photocopying or scanning of a blueprint for example.

Once the cards 20 have been completed, the storage container 10 may be installed, the cards placed therein, and the door 14 of the container closed. Preferred installation locations may include the interior surface of an exterior door 12 (as shown in FIG. 1) or other locations proximate to an exterior door 12, or proximate to an entryway to a floor of a multi-story building. The storage container 10 may alternatively be mounted to the exterior of the building, although this may not be optimal due to the possibility of vandalism or weather damage.

The sign 13 may then be displayed in a location that is readily visible to rescue personnel seeking to gain entry to a building or a story of a building, such as in a window 11 of an exterior door 12, or near a stairwell entry to a floor of the building for example.

In the event of an emergency, rescue personnel (e.g. firefighters or good Samaritans) arriving on the scene who see the sign 13 are immediately informed of the fact that an emergency information storage container 10 is installed in the building. At the time of entry to the building, the rescue personnel may quickly locate the storage container 10 at one of the installation locations described above, of which the rescue personnel may already be aware through notification by the manufacturer of the kit 80 or through previous experience.

Even if the sign 13 is not displayed or goes unnoticed, rescue personnel may quickly check the typical installation locations for a container 10 with an identifying mark indicative of the emergency information stored therein.

Upon locating and opening the storage container 10, the rescuers may quickly inspect the floor plan information card 30 for an “at-a-glance” summary of the locations of regular occupancy of any individuals and pets in the building. Rescue personnel may then begin searching in the indicated locations, rather than beginning their search in rooms in which occupants or pets are unlikely to be located, and may in this way improve the speed and effectiveness of their search and rescue efforts. Rescuers may choose to call out the names of the individuals or pets for whom markers are displayed on the floor plan 34 to facilitate rescue.

Even if the occupants or pets do not happen to be presently located in the locations identified by markers 36 and 38, the floor plan 34 may still be useful to rescuers as a map to the building. For example, the floor plan 34 may be helpful in ensuring that no remote or hidden corners of the floor are overlooked during a sweep of the building.

If the emergency situation warrants, the detailed occupant or pet information on cards 40 or 60 may also be reviewed to ascertain detailed occupant or pet information. This information may dictate the use of certain rescue procedures that are appropriate for a particular category of individual or pet. For example, if any of the occupants are small children, as may be determined from the date of birth field 47 of card 40 (FIG. 4), rescue procedures could be modified to include a search of certain hiding places that are only small enough to contain a small child, such as a closet or cabinet.

If any of the “last updated” fields, such as field 39 of card 30 (FIG. 3), indicate that the cards have not been updated in a long time, rescuers may choose to disregard the emergency information and instead may apply standard rescue procedures that would be used in the absence of any such emergency information.

When an individual or pet is successfully located and removed from a building by a rescuer, the medical information on cards 40 and 60 may be consulted to ensure that no inappropriate medical care is provided.

As will be appreciated by those skilled in the art, modifications to the above-described embodiment can be made without departing from the essence of the invention. For example, the container 10 is not necessarily made from metal. It may alternatively be made from other materials, such as fire-resistant materials providing a fire protection rating (e.g. as endorsed by standards bodies such as Underwriters Laboratories Inc.), as are used to construct known fire-resistant safes and fire-resistant filing cabinets.

In another alternative, a mechanism or device to assist in drawing the attention of rescuers to the installed storage container 10 may be provided. For example, a flashing beacon or alarm, possibly triggered by smoke or the presence of certain hazardous gases (e.g. carbon monoxide or radon), could be provided with the storage container 10 to provide a visual or auditory indication of the presence of the emergency information storage container 10. The beacon or alarm could be wired into a home security system which detects smoke or hazardous gases. The visual or auditory indication could be made distinctive from the beacons or alarms commonly used with smoke detectors, carbon monoxide detectors, or the like, so as to distinguish the storage container 10 from such detectors.

In place of a floor plan 34, card 30 may simply provide instructions to reach each individual or pet in the building. For example, the instructions could read: DIRECTIONS TO GET TO JOHN SMITH WHO OCCUPIES THE MASTER BEDROOM: GO UP STAIRS, TO END OF HALL, TURN RIGHT, OPEN DOOR. The underlined portions represent blanks which may be completed by an installer of the storage container 10.

In the event that it is not desired to list regular occupants of a building by name for fear of possible misuse of this information by non-rescue personnel gaining unauthorized access to the storage container 10, the cards 20 may simply indicate the number of regular occupants without listing any occupant names. In this case the locations of regular occupancy of the numbered occupants may or may not be included. This also applies to pets.

More generally, it is not necessary for the emergency information stored in the container 10 to include each of floor plan information, detailed occupant information, or detailed pet information as described above. Rather, only some of this information may be provided. The only requirement for the emergency information is that it should facilitate the location of regular building occupants in the event of an emergency situation, such as a fire, gas leak, radon leak, or carbon monoxide leak in a home for example. For example, although not preferred, the information could merely be a list of names of regular building occupants, which could be used by rescue personnel during an emergency to facilitate location of these occupants, e.g. through the calling out of the names by the rescue personnel.

It should also be recognized that more than one emergency information storage container 10 could be installed in a building. For example, a container 10 could be installed on each floor of a multi-story building. More than one container per floor could even be installed.

The storage container 10 and associated cards 20 are not necessarily sold commercially in the form of a kit 80 as shown in FIG. 6. Rather, a commercial service could be provided for professionally preparing the cards 20 and professionally installing the storage container 10. In this case all of the information on the cards 20, even the occupant-specific or pet-specific information, may be professionally printed for readability. Alternatively, the service may be just for installing the storage container 10 without preparing the cards 20. After the container 10 has been installed, the service may provide periodic reminders to the consumer (e.g. annually) to update the emergency information and “last-updated” date fields on the cards 20. The service may alternatively simply contact the consumer periodically (e.g. by telephone) to obtain any updates to the emergency information, print updated cards 20, and send the updated cards 20 to the consumer by mail for easy substitution for the outdated cards 20 in the container 10.

Other modifications will be apparent to those skilled in the art and, therefore, the invention is defined in the claims.

What is claimed is:

1. An emergency information storage container kit comprising:
a storage container; and
instructions for:
preparing human readable material to assist rescue personnel in the location of regular occupants of a building;
installing said storage container at an installation location at said building; and
storing said human readable material in said storage container.

2. The kit of claim 1 wherein said instructions for preparing human readable material include instructions for preparing names of individuals or pets regularly occupying said building.

3. The kit of claim 2 wherein said instructions for preparing human readable material further include instructions for indicating locations of regular occupancy in said building of said named individuals or pets.

4. The kit of claim 1 wherein said instructions for preparing human readable material include instructions for preparing a floor plan for at least a portion of said building.

5. The kit of claim 4 wherein said instructions for preparing human readable material further include instructions for indicating on said floor plan locations of regular occupancy in said building of individuals or pets regularly occupying said building.

6. The kit of claim 5 wherein said indicators comprise markers adherable to said floor plan.

7. The kit of claim 6 wherein said markers display the name of an individual or pet.

8. The kit of claim 3 wherein said instructions for preparing human readable material further include instructions for preparing medical information for said named individuals or pets.

9. The kit of claim 3 wherein said instructions for preparing human readable material further include instructions for preparing information indicating the age of individuals regularly occupying said building.

10. The kit of claim 3 wherein said instructions for preparing human readable material further include instructions for preparing information indicating pet species.

11. The kit of claim 1 further comprising:
forms which, after said preparing, comprise said human readable material.

12. The kit of claim 1 further comprising:
a computer readable medium storing computer-executable instructions which, when performed by a processor in a computing device, facilitate said preparing.

13. The kit of claim 1 further comprising:
a sign for displaying at said building to indicate the presence of said emergency information storage container.

14. The kit of claim 1 wherein said instructions for installing are for installing at an installation location proximate to an exterior door of said building.

15. The kit of claim 1 wherein said instructions for installing are for installing at an installation location proximate to an entryway to a floor of said building.

16. The kit of claim 1 wherein said storage container has markings providing an outward indication of the information stored therein.

17. The kit of claim 1 wherein said storage container is made from a fire resistant material.

18. The kit of claim 1 further comprising:
a beacon or alarm to facilitate location of said container during an emergency.

19. The kit of claim 19 wherein said beacon or alarm is activated by the presence of smoke or a hazardous gas.

20. The kit of claim 1 wherein said instructions for preparing human readable material include instructions for preparing a number of individuals or pets regularly occupying said building.

21. A method of assisting rescue personnel, comprising:
preparing human readable material to assist said rescue personnel in locating regular occupants of a building; and
installing a storage container at an installation location at said building for storing said human readable material.

22. The method of claim 21 wherein said human readable material comprises a number of individuals or pets regularly occupying said building.

23. The method of claim 21 wherein said human readable material comprises names of individuals or pets regularly occupying said building.

24. The method of claim 23 wherein said human readable material indicates locations of regular occupancy in said building of said named individuals or pets.

25. The method of claim 24 wherein said human readable material comprises a floor plan for at least a portion of said building.

26. The method of claim 25 wherein said human readable material further comprises indicators on said floor plan of locations of regular occupancy in said building of individuals or pets regularly occupying said building.

27. The method of claim 21 further comprising:
displaying a sign at said building to indicate the presence of said emergency information storage container.

28. The method of claim 21 wherein said installation location is proximate to an exterior door of said building.

29. The method of claim 21 wherein said installation location is proximate to an entryway to a floor of said building.

30. The method of claim 21 further comprising:
periodically updating said human readable material.

31. The method of claim 21 further comprising:
providing periodic reminders to update said human readable material.
